(19) United States
(12) Patent Application Publication
(10) Pub. No.: US 2019/0007277 A1
(43) Pub. Date: Jan. 3, 2019

(54) LARGE NETWORK SIMULATOR FOR DEVICE CHARACTERIZATION

(71) Applicant: Infinera Corporation, Sunnyvale, CA (US)

(72) Inventors: Mohit Misra, Bangalore (IN); Prakash Singh Bisht, Bangalore (IN); Ashwini Kumar Bhat, Bangalore (IN); Devaraj Jagannath Poojari, Bangalore (IN); Jyothi R, Bangalore (IN)

(73) Assignee: Infinera Corporation, Sunnyvale, CA (US)

(21) Appl. No.: 15/639,902

(22) Filed: Jun. 30, 2017

(51) Int. Cl. H04L 12/24

(52) U.S. Cl. CPC H04L 41/145; H04L 41/22

(57) ABSTRACT

Systems, methods, and devices for simulating a large network topology and characterizing network devices. the method includes generating a simulated open shortest path first (OSPF) network topology using a simulator device; generating link state advertisement (LSA) OSPF packets based on the simulated OSPF network topology using the simulator device; and communicating the OSPF packets to a gateway device for flooding a real OSPF network topology with the OSPF packets.

### FIELD

The disclosed embodiments relate to computer networking; and more specifically to simulation of open shortest path first (OSPF) network topology.

### BACKGROUND

In order to build a network topology and support label switching, network nodes need to store traffic engineering information (TE) about all of the other nodes. Different devices have different memory and CPU capacity however, and it may be too expensive to replicate the entire network for testing.

### SUMMARY

Some implementations provide a method for simulating a network topology. The method includes generating a simulated open shortest path first (OSPF) network topology using a device; generating OSPF link state advertisement (LSA) packets based on the simulated OSPF network topology using the device; and communicating the OSPF LSA packets to a gateway for flooding a real OSPF network with the OSPF LSA packets.

In some implementations, the method includes the OSPF LSA packets into a link state database of a real OSPF network gateway. In some implementations, the gateway includes a simulator gateway device which is in communication with a real network gateway. In some implementations, the method includes displaying the simulated OSPF network topology on a graphical user interface (GUI) of the device. In some implementations, the OSPF LSA packets include traffic engineering (TE) information. In some implementations, the method includes inputting commands from a user to the device to modify the simulated OSPF network topology. In some implementations, the nodes in the simulated OSPF topology include a resource reservation protocol (RSVP) node for supporting a subnetwork connection (SNC).

Some implementations provide a device for simulating a network topology. The device includes generator circuitry configured to generate a simulated open shortest path first (OSPF) network topology. The generator circuitry is also configured to generate OSPF link state advertisement (LSA) packets based on the simulated OSPF network topology. The device also includes communications circuitry configured to communicate the OSPF LSA packets to a gateway for flooding a real OSPF network topology with the OSPF LSA packets.

In some implementations, the device also includes circuitry configured to inject the OSPF LSA packets into a link state database of a real network gateway. In some implementations, the gateway includes a simulator gateway which is in communication with a real network gateway. In some implementations, the device also includes a graphical user interface (GUI) configured to display the simulated OSPF network topology. In some implementations, the OSPF LSA packets include traffic engineering (TE) information. In some implementations, the device also includes circuitry configured input commands from a user to modify the simulated OSPF network topology. In some implementations, the device also includes circuitry configured to generate a simulated OSPF node which includes a simulated store resource reservation protocol (RSVP) node for supporting a subnetwork connection (SNC).

Some implementations provide a non-transitory computer-readable medium on which instructions are stored which, if executed by a processor of a device for simulating a network topology, cause the device to generate a simulated open shortest path first (OSPF) network topology; generate OSPF link state advertisement (LSA) packets based on the simulated OSPF network topology; and communicate the OSPF LSA packets to a gateway for flooding a real OSPF network with the OSPF LSA packets.

In some implementations, the instructions, if executed by the processor, further cause the device to inject the OSPF LSA packets into a link state database of a real network gateway. In some implementations, the gateway includes a simulator gateway device which is in communication with a real network gateway device. In some implementations, the instructions, if executed by the processor, further cause the device to display the simulated OSPF network topology on a graphical user interface (GUI). In some implementations, the OSPF LSA packets include traffic engineering (TE) information. In some implementations, the instructions, if executed by the processor, further cause the device to input commands from a user to the device to modify the simulated OSPF network topology.

### BRIEF DESCRIPTION OF THE DRAWINGS

FIG. 1 is a system diagram illustrating an example system for simulating large networks;

FIG. 2 is a block diagram illustrating a simulator controller, topology builder, and LSA generator of the system of FIG. 1;

FIG. 3 is a flow chart illustrating an example method for generating and injecting OSPF LSA packets from a simulated network to a real network using the system of FIG. 1;

FIG. 4 is a network diagram illustrating a real OSPF network topology in communication with a virtual OSPF network topology; and

FIG. 5 is a block diagram illustrating a header and payload for an example OSPF LSA packet.

### DETAILED DESCRIPTION

In order to build a network topology and support label switching, network nodes need to store traffic engineering information (TE) about all of the other nodes. Different devices have different memory and CPU capacity however. It may be desired to characterize the memory and CPU behavior of different devices as a function of network size, e.g., expressed as a number of nodes and links. It may be too expensive to replicate the entire network for testing however, or to simulate the network, or to have a third party do these things. Accordingly, a large topology simulator (LTS) can be constructed to create a simulated topology, generate link state advertisements (LSAs) based on the simulated topology, and to inject the LSAs into a real network by inserting them into the link state database of a gateway node of the real network. Testing can then be performed on the devices making up the real network as though the real network included the simulated topology.

Open Shortest Path First (OSPF) is an interior gateway protocol (IGP) for routing Internet Protocol (IP) packets solely within a single routing domain, such as an autonomous system. It gathers link state information from available routers and constructs a topology map of the network. The topology is presented as a routing table to the Internet Layer which routes datagrams based solely on the destination IP address found in IP packets. OSPF-TE is an extended version of the protocol to carry traffic engineering information about the nodes and links of the network. Each node running OSPF-TE protocol floods information about the traffic engineering attributes of all its links such as bandwidth, cost, switching capability etc. Flooding is a network routing technique where incoming data received by a network device is transmitted from the network device on every outgoing link except the link on which the packet was received, with the goal of delivering the data to all reachable devices on the network. A node running OSPF-TE protocol can build complete topology graph of the network itself with the information received from its OSPF neighbors.

The OSPF-TE protocol can be used to distribute traffic engineering information about nodes and links for Generalized Multi-Protocol Label Switching (GMPLS) operation. After the traffic engineering information is distributed, each node in the network has the same view of the network topology.

Traffic engineering information received by OSPF-TE can be used to compute paths for an end to end sub-network connection (SNC) for bandwidth provisioning from one node to another in the network.

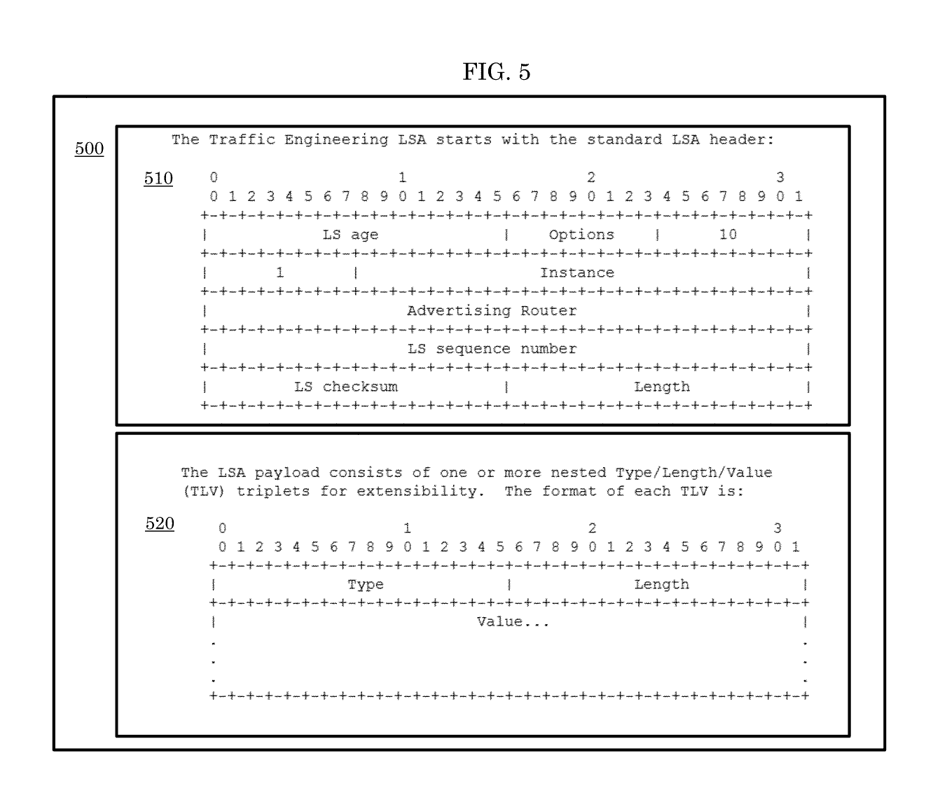

Each OSPF node floods traffic engineering (TE) information about its own links in the network and stores TE information about all other nodes in the network in order to build network topology. The TE extensions to OSPF-v2 have been described in detail in the Internet Engineering Task Force Request for Comments (IETF RFC) 3630. FIG. 5 is a block diagram illustrating the format of an OSPF-TE LSA packet 500 as defined in IETF RFC 3630. It is noted that in other implementations, any suitable packet format can be used. Packet 500 includes a header 510 and a payload 520. All OSPF LSA packets begin with a common 20-byte header. This header contains enough information to uniquely identify the LSA. The header fields are. LS Age, which indicates the time in seconds since the LSA was originated; LS Type, which incidates the LS type field indicates the function performed by the LSA; Link State ID, which indicates the originating router's identifier for the LSA; Advertising Router, which indicates the Router ID of the router that originated the LSA; LS sequence number, where successive instances of an LSA are given successive LS sequence numbers; and LS checksum, which indicates a checksum of of the complete contents of the LSA, exclusing the LS age field. Payload 520 consists of one or more nested Type/Length/Value (TLV) triplets for extensibility. Packet 500 in this example is a Type 10 area-local opaque LSA packet, as defined by IETF RFC 2370, which indicates information which should be flooded. Accordingly, LS type field indiates a Type 10 area-local opaque LSA packet.

Typical traffic engineering information of a link includes traffic engineering metric, maximum bandwidth of the link, maximum reservable bandwidth of the link, unreserved bandwidth and the administrative group. The memory required on each node and the performance of the protocol for processing OSPF updates may depend directly on the size of the network, and may need to be characterized for proper functioning of the protocol.

OSPF routers can have different memory and central processing unit (CPU) capacities. These differences can be due, for example, to different hardware being used in the controller cards of these products. In a network, such devices may participate in the same OSPF-TE topology however. Thus the size of the OSPF network can impact each product differently. Because such products can be deployed in large numbers in a single OSPF network, it may be desired to provide a mechanism which characterizes the memory and CPU behavior of such products (i.e., nodes and links) as a function of network size (e.g., number of nodes and links).

There are many different ways in which nodes and links in a large network can be characterized. However it is typical for hundreds, or even thousands, of these nodes to be deployed in a network. It may thus be cost prohibitive to replicate such a network in the lab in order to characterize and certify the protocol behavior.

A simulation platform (e.g., a personal computer (PC) or virtual machine (VM)) can be used to run instances of OSPF routing software, and to connect them to form a simulated large OSPF network. This approach may be less costly than replicating the network for testing purposes. However managing a suitably large farm of PCs and VMs and installing node and/or link software on each can entail an unacceptably large amount operational overhead. In addition, it may be difficult to build an arbitrary network topology using this scheme.

A third party commercial protocol tester (e.g., such as available from Agilent™ and Ixia™) can be used to simulate a large network. Such commercial testers are very expensive however, and may not support customized and/or proprietary OSPF data. Accordingly, it may be desired to provide other simulation or characterization devices and methods which may be more cost effective or simpler to operate.

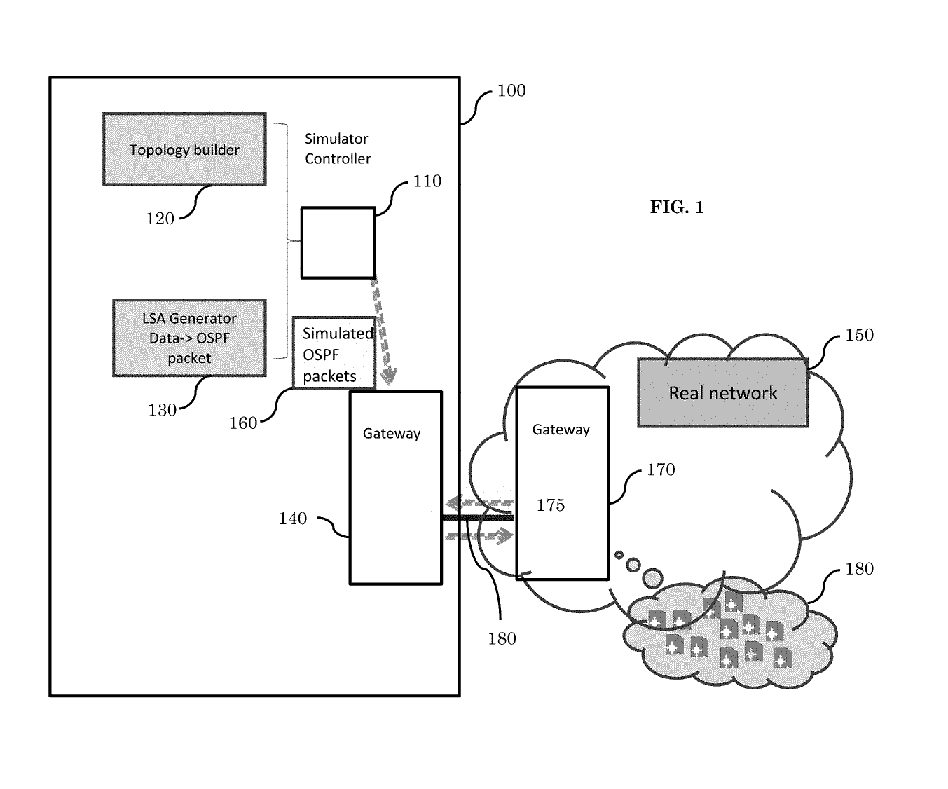

FIG. 1 is a system diagram illustrating an example system 100 for simulating large networks. Such systems can be referred to as large topology simulators (LTS). LTS system 100 includes a simulation device, simulator controller 110 (which includes a topology builder 120 and a link state advertisement (LSA) generator 130), and a simulator gateway 140. Simulator gateway 140 is in communication with a “real” network 150 (i.e., physical, non-simulated network). It is noted that this division and arrangement of the components of system 100 is only exemplary, and that other suitable arrangements will be evident to those of skill in the art. It is also noted that in the example of system 100, real network 150 is described as in communication with, but not a part of, LTS system 100. In other examples however, the real network could be considered to be a part of the LTS system.

The various components of the LTS system 100 are operable to build a simulated topology, to generate OSPF LSA packets corresponding to the nodes of the simulated topology, and to transmit the OSPF LSA packets to real network 150.

Simulator controller 110 can include any computing device or devices suitable for generating and displaying network topologies, such as a computer server, laptop, server farm, or the like. Such devices may include at least one processing device, such as a general purpose central processing unit (CPU) and/or a graphics processing unit (GPU), memory and/or storage. The memory and/or storage can include a non-transitory computer readable medium.

The topology builder 120 is executed by the simulator controller 110, and includes an interface, such as a graphical user interface (GUI), for user- or automatic generation of a simulated network topology. Topology builder 120 includes or can access models of various real-world nodes, links, and other equipment, which reflect the properties of these devices, for generating an overall model of a network topology. In some implementations, a user can modify or “tweak” the size of the topology and/or the configuration of each simulated node using the interface. In some implementations, the user can generate proposed models of nodes, links, or other devices that to not correspond to existing real-world devices.

LSA generator 130 is also executed by the simulator controller 110, and inputs data generated by the topology builder 120, as well as equipment models of real-world or proposed devices that are relevant to the generated topology. The equipment models can be input from a local memory or storage, or can be input from a remote source. Based on the simulated node/link topology and the equipment models, LSA generator 130 generates and encodes OSPF LSA packets 160 for all simulated nodes. The generated OSPF LSA packets 160 for each simulated node are indistinguishable from packets that a real OSPF router corresponding to that simulated node would have generated using the same configuration.

Simulator gateway 140 can include any computing device or devices suitable for generating and displaying network topologies, such as a computer server, laptop, server farm, or the like. Such devices may include at least one processing device, such as a general purpose central processing unit (CPU) and/or a graphics processing unit (GPU), memory and/or storage. The memory and/or storage can include a non-transitory computer readable medium. In the example system 100, simulator gateway 140 is implemented independently from simulator controller 110. It is noted however that in some implementations, simulator controller 110 and simulator gateway 140 could be implemented using the same physical device. Various alternative arrangements will be evident to those skilled in the art.

Simulator gateway 140 receives simulated OSPF LSA packets 160 from simulator controller 110 over a suitable communications medium, such as an internal bus of LTS system 100 or a fiber-optic link, from simulator controller 110. Simulator gateway 140 floods the OSPF LSA packets 160 into a gateway node 170 of real network 150 over a dynamic circuit network (DCN) connection 180. The DCN connection 180 is a computer communications medium which can provide a fixed bandwidth connection, such as a fiber-optic connection, between the simulator controller 110 device and the simulator gateway 140 device. It is noted that in other examples, simulator gateway 140 can flood OSPF LSA packets 160 into gateway node 170 over any suitable computer communications medium instead of, or in addition to, a DCN. Gateway node 170 injects the OSPF LSA packets 160 directly into its own OSPF link state database (LSDB) 175, which can be stored in a hardware buffer or other memory of the gateway node 170. As the OSPF LSA packets 160 are injected, gateway node 170 floods this LSDB information, including OSPF LSA packets 160, into real network 150 over the various nodes and links 180 comprising the real network 150.

Real Network 150 is a OSFP-based network which includes gateway node 170 and various actual nodes and links 180. Nodes and links 180 can include any suitable networking devices and links, such as, for example, optical or other types of routers, wavelength division multiplexed terminals, reconfigurable optical add-drop multiplexers, and various physical links among the devices. Such physical links can include, for example, fiber optic links, cable connections, and/or wireless air interfaces among the networking devices. In response to receiving the flooded LSDB information (i.e., OSFP packets 160), nodes and links 180 behave in the same way that they would behave in response to OSFP LSA packets from within the topology of real network 150. Testing for memory, performance and/or scale can be performed on one or more node devices of real network 150, such as a router.

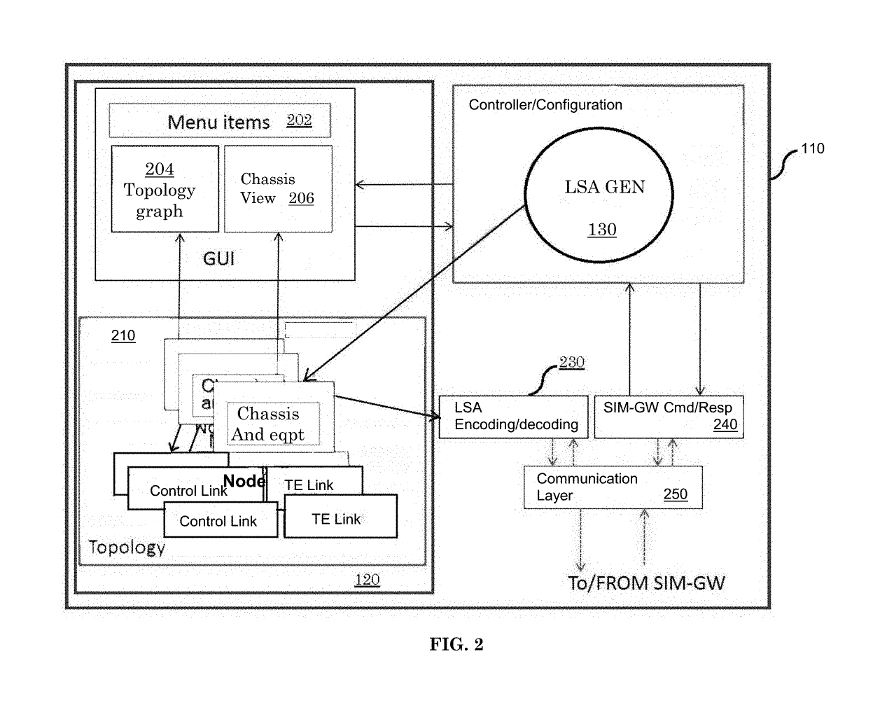

FIG. 2 is a block diagram illustrating further aspects of simulator controller 110, topology builder 120, and LSA generator 130.

Topology builder 120 includes GUI 200. GUI 200 facilitates user interaction with topology builder 120 and displays various images and controls on a physical display, such as a monitor, which is a part of or in communication with simulator controller 110. Any suitable displays or controls may be shown on GUI 200. In the example of FIG. 2, GUI 200 displays various menu items 202 as well as a topology graph 204 and chassis view 206 of the simulated network topology 210 being generated by topology builder 120. Menu items 202 include any suitable controls for specifying details of the simulated network topology 210, such as number and type of nodes (e.g., core optical router, edge router, gateway router, etc.), number and type of links (e.g., fiber-optic link, cable link, wireless air interface, etc.) Topology graph 204 displays a topology graph of the current simulated topology (e.g., illustrating the various nodes of the current simulated topology and links between and among the nodes). Chassis view 206 displays a representation of the specific physical chassis and equipment of particular nodes and links of simulated network topology 210. Topology graph 204 and chassis view 206 input data from and display representations of aspects of the simulated network topology 210, and the user can view and modify aspects of simulated network topology 210 (e.g., number and types of nodes or links; types of chassis for a given node, TE information for nodes or links etc.) by interacting with topology graph 204, chassis view 206, and menu items 202.

In the example implementation of FIG. 2, GUI 200 provides several possible user inputs; and user inputs to GUI 200 are communicated to a configuration controller 220 of the simulator controller 110. User inputs which alter the topology are input to LSA generator 130, which encodes OSPF LSAs using these inputs. The LSA generator 130 alters topology 210 in topology builder 120 based on these inputs. For example, user inputs which modify the size of the topology (e.g., number of nodes and/or links, or length of links), or the configuration of simulated nodes, are input to LSA generator 130, which effects these modifications to topology 210 It is noted that in other implementations, the user inputs may directly control elements of topology 210.

User inputs which perform other functions are routed accordingly. For example, user inputs to instruct generation of OSPF LSA packets 160 can be input to configuration controller 220 from GUI 200. In this case, LSA Generator 130 can communicate a signal to topology builder 120 to output current simulated topology information to an LSA encoder/decoder 230 device, which generates the OSPF LSA packets 160. The LSA encoder/decoder 230 may include a portion of a memory of the simulator controller 110, for example. User inputs an also be input to configuration controller 220 from GUI 200 to inject the OSPF LSA packets 160 to the real network. In this case, configuration controller 220 communicates a signal to simulated gateway command/responder (SIM-GW Cmd/Resp) 240 which communicates the OSPF LSA packets 160 from LSA encoder/decoder 230 to the simulator gateway 140 via a communication layer 250

It is noted that the particular functional arrangement of simulator controller 110 shown in FIG. 2 is exemplary, and many other possible configurations will be evident to those of skill in the art, including implementations which include more or fewer components.

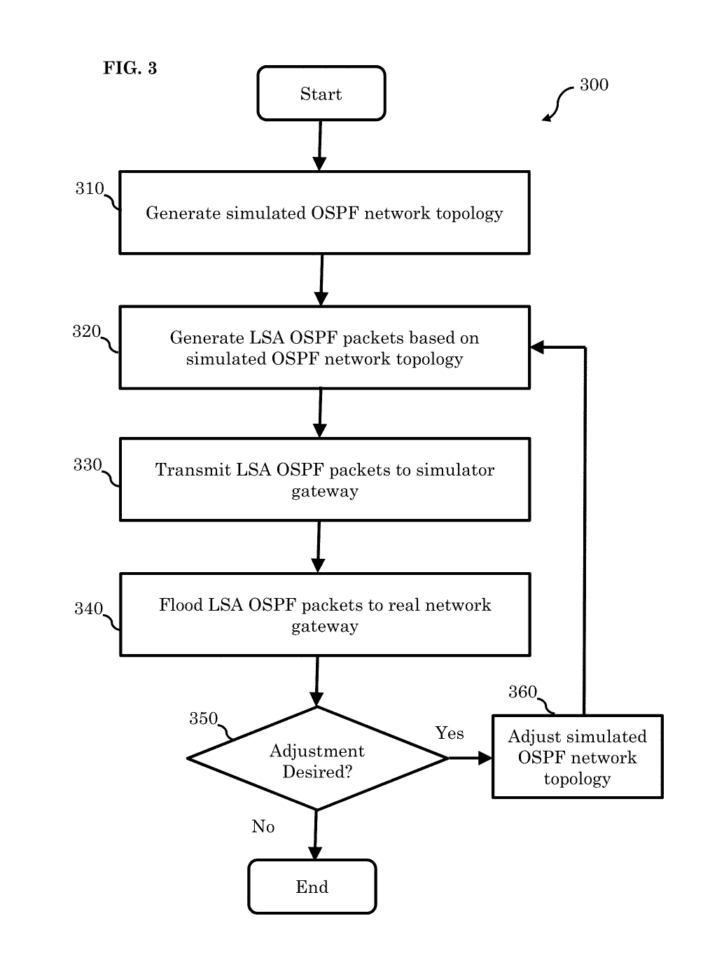

FIG. 3 is a flow chart illustrating an example method 300 for generating and injecting OSPF LSA packets from a simulated network to a real network, e.g., using a simulator controller, such as simulator controller 110 and associated components as shown and described with respect to FIGS. 1 and 2.

A simulated OSPF network topology is generated by the simulator controller in step 310. The simulated OSPF network topology can be generated, for example, using simulator controller. A user can initiate generation of the simulated OSPF network topology, e.g., using a GUI such as GUI 200, and can control the number and types of nodes and/or links which make up the simulated OSPF network topology. In some implementations, the user can select particular types of nodes and/or links (i.e., models of real-world nodes and/or links having specific characteristics and/or features, such as traffic engineering specifications, or models of proposed devices) from a library of templates (e.g., using GUI 200.) In some implementations, the user can select the entire simulated OSPF network topology, or a portion of the simulated OSPF network topology, from a library of templates (e.g., using GUI 200.)

OSPF LSA packets are generated for each simulated node in step 320 by simulator controller based on the simulated OSPF network topology generated in step 310. The OSPF LSA packets, which include the LSAs for each simulated node, are indistinguishable from packets that a real OSPF router corresponding to that simulated node would have generated using the same configuration.

After the simulated network topology has been generated, the generated OSPF LSA packets are communicated from the simulator controller to a simulator gateway node, such as simulator gateway 140 as shown and described with respect to FIGS. 1 and 2, in step 330. The generated OSPF LSA packets can be communicated to the simulator controller in response to any suitable criterion, such as a user command, or automatically following automatic generation of the simulated network topology, for example. The simulator gateway node floods the OSPF LSA packets to a real network gateway, such as gateway node 170, in step 340. The simulator gateway node can transmit the generated OSPF LSA packets to the real network gateway over any suitable communications medium, such as a DCN. In typical applications, the real network will respond to flooding by the generated OSPF LSA packets as though they originated from real nodes, such as within the real network. Any desired testing can be conducted on the real network after it has been flooded with the generated OSPF LSA packets. For example, performance, scale and memory problems can occur in a OSPF router due to a large topology. If the OSPF router memory is insufficient (or if there is a memory leak) the OSPF router cannot store data for the entire topology. This situation may result in a shut down the OSPF router. Also, if the number of LSAs is too large for the OSPF router memory, the OSPF router may encounter performance issues such as inability to compute the routes quickly enough if topology changes occur in the network, which can lead to to ‘black-holing’ of packets in the network.

On a condition 350 that further adjustment and simulation of the OSPF network topology is desired, the user can adjust the simulated OSPF network topology (e.g., using a GUI such as GUI 200 as shown and described with respect to FIGS. 1 and 2) in step 360, and the flow can return to step 320 for generation of a revised set of OSPF LSA packets based on the adjusted OSPF network topology.

A Subnetwork connection (SNC) is an end to end path, provisioned circuit between a series of nodes for carrying user traffic from one node to another. The optimal path of a SNC can be determined using a path computation algorithm which can be run on the OSPF TE-LSDB. Depending upon on the network topology, thethe SNC may be calculated to extend along a long path (e.g., 50+ nodes in the network). Because it could be cost prohibitive to test such a scenario, in some implementations, it may be desired to support a subnetwork connection (SNC) using an LTS wherein each simulated node in the LTS behaves as a RSVP node as well as a OSPF-TE node. By setting up a SNC through the simulated network of the LTS, a device in the real network that is part of the SNC can be tested (e.g., to characterize its memory and CPU behavior) for a larger SNC than would be possible to implement in the real network alone.

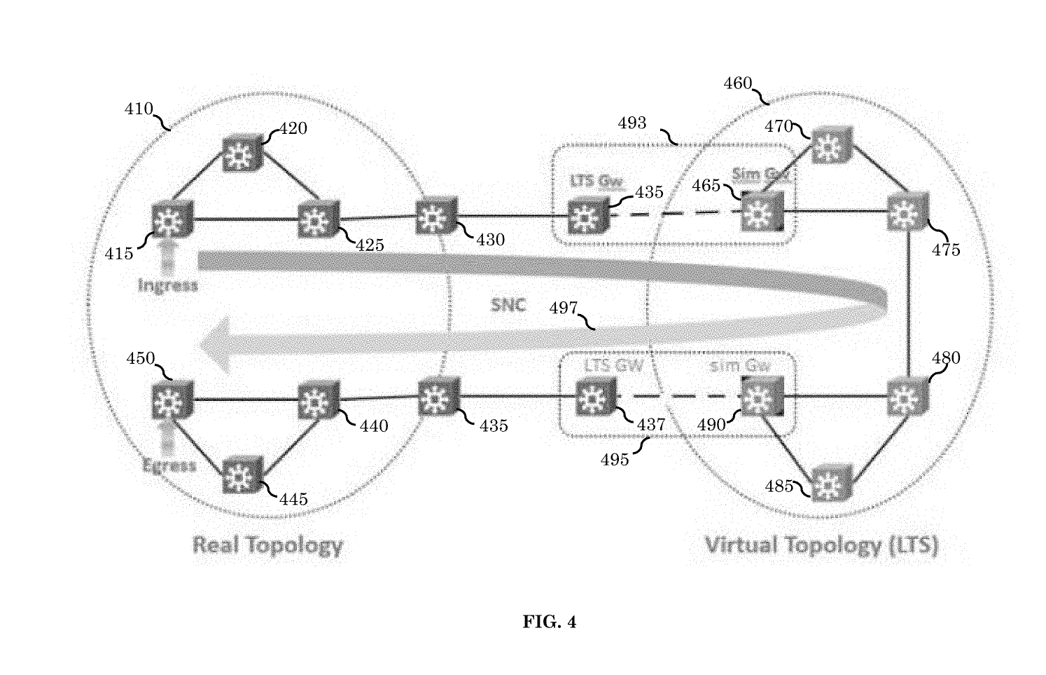

FIG. 4 is a network diagram illustrating a real OSPF network topology 410 in communication with a virtual OSPF network topology 460. Real OSPF network topology 410 includes various physical nodes 415, 420, 425, 430, 435, 440, 445, 450 (e.g., core routers, edge routers, terminals, etc.) and links (e.g., fiber-optic links, cable links, wireless air interfaces, etc.) connecting these nodes as shown. Node 430 is also in communication with a LTS gateway 455 device, and node 435 is in communication with a second LTS gateway 437 device.

Virtual OSPF network topology 460 includes various virtual (e.g., simulated) nodes 465, 470, 475, 480, 485, 490 and virtual links connecting these nodes as shown. Nodes 465 and 490 also function as a simulated gateways for virtual OSPF network topology 460. Node 465 is in communication with node 430 via a suitable communications medium 493, such as a DCN connection. Node 490 is in communication with node 435 via a suitable communications medium 495, such as a DCN connection.

In the example of FIG. 4, node 415 is an ingress node for a SNC message 497, and node 450 is an egress node for SNC message 497.

Each node in virtual OSPF network topology 460 (i.e., each simulated/virtual node 465, 470, 475, 480, 485, 490) can maintain its own database to track SNC messages, such as SNC message 497, flowing through it. Each of virtual nodes 465, 470, 475, 480, 485, 490 can run an instance of a Resource Reservation Protocol (RSVP) session and can store a hash map for message identities. The RSVP protocol is described in IETF RFC 2205 and its TE extensions are described in IETF RFC 3209.

It should be understood that many variations are possible based on the disclosure herein. Although features and elements are described above in particular combinations, each feature or element may be used alone without the other features and elements or in various combinations with or without other features and elements.

The methods provided may be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors may be manufactured by configuring a manufacturing process using the results of processed hardware description language (HDL) instructions and other intermediary data including netlists (such instructions capable of being stored on a computer readable media). The results of such processing may be maskworks that are then used in a semiconductor manufacturing process to manufacture a processor which implements aspects of the embodiments.

The methods or flow charts provided herein may be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for simulating a network topology, comprising:
generating a simulated open shortest path first (OSPF) network topology using a device;
generating OSPF link state advertisement (LSA) packets based on the simulated OSPF network topology using the device; and
communicating the OSPF LSA packets to a gateway for flooding a real OSPF network with the OSPF LSA packets.

2. The method of claim 1, further comprising injecting the OSPF LSA packets into a link state database of a real OSPF network gateway.

3. The method of claim 1, wherein the gateway comprises a simulator gateway device which is in communication with a real network gateway.

4. The method of claim 1, further comprising displaying the simulated OSPF network topology on a graphical user interface (GUI) of the device.

5. The method of claim 1, wherein the OSPF LSA packets include traffic engineering (TE) information.

6. The method of claim 1, further comprising inputting commands from a user to the device to modify the simulated OSPF network topology.

7. The method of claim 1, wherein nodes in the simulated OSPF topology comprise a resource reservation protocol (RSVP) node for supporting a subnetwork connection (SNC).

8. A device for simulating a network topology, comprising:
generator circuitry configured to generate a simulated open shortest path first (OSPF) network topology;
the generator circuitry further configured to generate OSPF link state advertisement (LSA) packets based on the simulated OSPF network topology; and
communications circuitry configured to communicate the OSPF LSA packets to a gateway for flooding a real OSPF network topology with the OSPF LSA packets.

9. The device of claim 8, further comprising circuitry configured to inject the OSPF LSA packets into a link state database of a real network gateway.

10. The device of claim 8, wherein the gateway comprises a simulator gateway which is in communication with a real network gateway.

11. The device of claim 8, further comprising a graphical user interface (GUI) configured to display the simulated OSPF network topology.

12. The device of claim 8, wherein the OSPF LSA packets include traffic engineering (TE) information.

13. The device of claim 8, further comprising circuitry configured input commands from a user to modify the simulated OSPF network topology.

14. The device of claim 8, further comprising circuitry configured to generate a simulated OSPF node which comprises a simulated store resource reservation protocol (RSVP) node for supporting a subnetwork connection (SNC).

15. A non-transitory computer-readable medium on which instructions are stored which, if executed by a processor of a device for simulating a network topology, cause the device to:
generate a simulated open shortest path first (OSPF) network topology;
generate OSPF link state advertisement (LSA) packets based on the simulated OSPF network topology; and
communicate the OSPF LSA packets to a gateway for flooding a real OSPF network with the OSPF LSA packets.

16. The non-transitory computer-readable medium of claim 15, wherein the instructions, if executed by the processor, further cause the device to inject the OSPF LSA packets into a link state database of a real network gateway.

17. The non-transitory computer-readable medium of claim 15, wherein the gateway comprises a simulator gateway device which is in communication with a real network gateway device.

18. The non-transitory computer-readable medium of claim 15, wherein the instructions, if executed by the processor, further cause the device to display the simulated OSPF network topology on a graphical user interface (GUI).

19. The non-transitory computer-readable medium of claim 15, wherein the OSPF LSA packets include traffic engineering (TE) information.

20. The non-transitory computer-readable medium of claim 15, wherein the instructions, if executed by the processor, further cause the device to input commands from a user to the device to modify the simulated OSPF network topology.
